(19) United States
(12) Patent Application Publication
(10) Pub. No.: US 2025/0372989 A1
(43) Pub. Date: Dec. 4, 2025

(54) WIRING HARNESS FIXTURE AND WIRING HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Hiroki ITAKA, Mie (JP)

(21) Appl. No.: 18/873,326

(22) PCT Filed: Jun. 8, 2023
(86) PCT No.: PCT/JP2023/021323

§ 371 Date: Dec. 10, 2024

(30) Foreign Application Priority Data
Jun. 13, 2022 (JP) 2022-095016

(51) Int. Cl. H02G 3/32; H01R 24/20; H02G 11/00

(52) U.S. Cl. CPC H02G 3/32; H01R 24/20; H02G 11/003

(57) ABSTRACT

The present disclosure provides a wire harness fixture that makes it possible to easily detach an electric wire member from an attachment target and also provides a wire harness. A wire harness fixture (12) according to one embodiment of the present disclosure comprises a fixing member (20) that is fixed to an attachment target (P) and an electric wire holding member (30) for holding an electric wire member (11). The electric wire holding member (30) has a first connection portion (31). The fixing member (20) has a second connection portion (21) that is removably connected to the first connection portion (31). The electric wire holding member (30) is attached to the fixing member (20) in a separable manner by the connection between the first connection portion (31) and the second connection portion (21).

### TECHNICAL FIELD

The present disclosure relates to a wiring harness fixture and a wiring harness.

### BACKGROUND

For example, a wiring harness fixture described in Patent Document 1 is provided with a fixing portion to be fixed to an attachment object such as a vehicle body panel and a holding portion for holding a wire member. The fixing portion includes a pair of retaining claws to be locked to the attachment object. By locking the retaining claws to the attachment object, the wiring harness fixture for holding the wire member is fixed to the attachment object.

### PRIOR ART DOCUMENT

### Patent Document

Patent Document 1: JP H07-336846 A

### SUMMARY OF THE INVENTION

### Problems to be Solved

In the wiring harness fixture of Patent Document 1, the retaining claws of the fixing portion may be deformed, for example, due to long-term use in a situation subject to vehicle vibration. If the retaining claws are deformed, the fixing portion cannot be detached from the attachment object or it may be difficult even if the fixing portion can be detached.

The present disclosure aims to provide a wiring harness fixture and a wiring harness enabling a wire member to be easily detached from an attachment object.

### Means to Solve the Problem

The present disclosure is directed to a wiring harness fixture with a fixing member to be fixed to an attachment object and a wire holding member for holding a wire member, one of the fixing member and the wire holding member including a first coupling portion, the other of the fixing member and the wire holding member including a second coupling portion to be detachably coupled to the first coupling portion, and the wire holding member being separably attached to the fixing member by coupling the first and second coupling portions.

The present disclosure is also directed to a wiring harness with the above wiring harness fixture and a wire member to be held by the wire holding member of the wiring harness fixture.

### Effect of the Invention

A wiring harness fixture and a wiring harness of the present disclosure exhibit an effect of enabling a wire member to be easily detached from an attachment object.

### BRIEF DESCRIPTION OF THE DRAWINGS

FIG. 1 is a perspective view of a wiring harness in an embodiment.

FIG. 2 is an exploded perspective view of a wiring harness fixture in the embodiment.

FIG. 3 is a section of the wiring harness in the embodiment.

FIG. 4 is a perspective view of a wiring harness in a modification.

FIG. 5 is an exploded perspective view of a wiring harness fixture in the modification.

### DETAILED DESCRIPTION TO EXECUTE THE INVENTION

### Description of Embodiments of Present Disclosure

First, embodiments of the present disclosure are listed and described.

[1] The wiring harness fixture of the present disclosure is provided with a fixing member to be fixed to an attachment object and a wire holding member for holding a wire member, one of the fixing member and the wire holding member including a first coupling portion, the other of the fixing member and the wire holding member including a second coupling portion to be detachably coupled to the first coupling portion, and the wire holding member being separably attached to the fixing member by coupling the first and second coupling portions.

According to this configuration, even in a situation where it is difficult to detach the fixing member from the attachment object, the wire member can be easily detached, together with the wire holding member, from the fixing member fixed to the attachment object by releasing a coupled state of the first and second coupling portions.

[2] In [1] described above, the first coupling portion may include a locking claw, and the second coupling portion may include a locked portion to be locked by the locking claw.

According to this configuration, the wire holding member can be attached to the fixing member by locking the locking claw of the first coupling portion and the locked portion of the second coupling portion.

[3] In [2] described above, a plurality of the locking claws and a plurality of the locked portions may be provided.

According to this configuration, the first and second coupling portions can be firmly coupled by a plurality of pairs of the locking claw and the locked portion. Further, a load applied to one locking claw during vibration or the like can be reduced.

[4] In [3] described above, the first coupling portion may include a displacement allowing portion for allowing a displacement of one of the plurality of locking claws in a direction to release locking to the locked portion.

According to this configuration, the locking of the locking claw to the locked portion can be easily released by displacing the locking claw by the displacement allowing portion.

[5] In [4] described above, the first coupling portion may include an operating portion for displacing the locking claw in cooperation with the displacement allowing portion.

According to this configuration, the locking claw can be easily displaced by the operating portion cooperating with the displacement allowing portion. Therefore, the locking of the locking claw to the locked portion can be more easily released by the operating portion.

[6] In [5] described above, the fixing member may include the second coupling portion, the wire holding member may include the first coupling portion having the operating portion and a holding portion for holding the wire member, and the holding portion may be provided independently of the operating portion not to interfere with the operating portion in the wire holding member.

According to this configuration, a force transmitted from the wire member is less likely to be transmitted to the operating portion via the holding portion. Therefore, it can be suppressed that the operating portion is moved by the force transmitted from the wire member and, as a result, the locking claw is displaced to inadvertently release the locking to the locked portion.

[7] In [6] described above, the first coupling portion may include a groove portion provided between the operating portion and the holding portion.

According to this configuration, the holding portion can be configured not to interfere with the operating portion by the groove portion provided between the holding portion and the operating portion.

[8] In [6] or [7] described above, the first coupling portion may include a base portion, the plurality of locking claws may extend from the base portion, and the operating portion may project from an end surface of the base portion.

According to this configuration, since projecting from the base portion, the operating portion can be easily operated.

[9] In [8] described above, the holding portion may include a projecting portion projecting from the end surface of the base portion.

According to this configuration, the projecting portion of the holding portion and the operating portion project from the same end surface of the base portion. Thus, parts projecting from the base portion can be collected on the same end surface. Therefore, the interference of the wiring harness fixture and peripheral parts can be suppressed.

[10] In any one of [4] to [9] described above, the displacement allowing portion may include a slit formed in the first coupling portion and a flexible portion deflectable due to presence of the slit, and the locking claw allowed to be displaced by the displacement allowing portion may be provided on the flexible portion.

According to this configuration, the locking claw can be easily displaced by the slit and the flexible portion provided in the first coupling portion. Therefore, the locking of the locking claw to the locked portion can be more easily released.

[11] In [10] described above, the first coupling portion may include an operating portion for displacing the locking claw in cooperation with the displacement allowing portion, and the operating portion may be provided at a position corresponding to a central part in an extension direction of the slit in the flexible portion.

According to this configuration, the flexible portion is more easily deflected in the central part in the extension direction of the slit. That is, since the operating portion is provided in an easily deflected part in the flexible portion, the locking of the locking claw to the locked portion can be more easily released by the operating portion.

[12] In any one of [4] to described above, the locking claw allowed to be displaced by the displacement allowing portion may be a first locking claw and each locking claw other than the first locking claw, out of the plurality of locking claws, may be a second locking claw, one first locking claw may be provided, a plurality of the second locking claws may be provided, and a width of the first locking claw may be set to be larger than that of each of the plurality of second locking claws.

According to this configuration, the first and second coupling portions can be suitably coupled by setting the width of the first locking claw displaceable by the displacement allowing portion larger than that of each second locking claw.

[13] Further, the wiring harness of the present disclosure is provided with the wiring harness fixture of any one of [1] to described above, and a wire member to be held by the wire holding member of the wiring harness fixture.

According to this configuration, effects similar to those of the wiring harness fixture of [1] described above can be obtained.

### Details of Embodiment of Present Disclosure

Specific examples of a wiring harness fixture and a wiring harness of the present disclosure are described below with reference to the drawings. For the convenience of description, some components may be shown in an exaggerated or simplified manner in each drawing. Further, a dimension ratio of each part may be different in each drawing. Further, “parallel” and “perpendicular” in this specification mean not only strictly parallel and perpendicular, but also substantially parallel and perpendicular within a range in which functions and effects in this embodiment are achieved.

Further, “facing each other” in this specification indicates that surfaces or members are at positions in front of each other, and means not only a case where the surfaces or members are at positions perfectly in front of each other, but also a case where the surfaces or members are at positions partially in front of each other. Further, “facing each other” in this specification means both a case where another member different from two parts is interposed between the two parts and a case where nothing is interposed between the two parts.

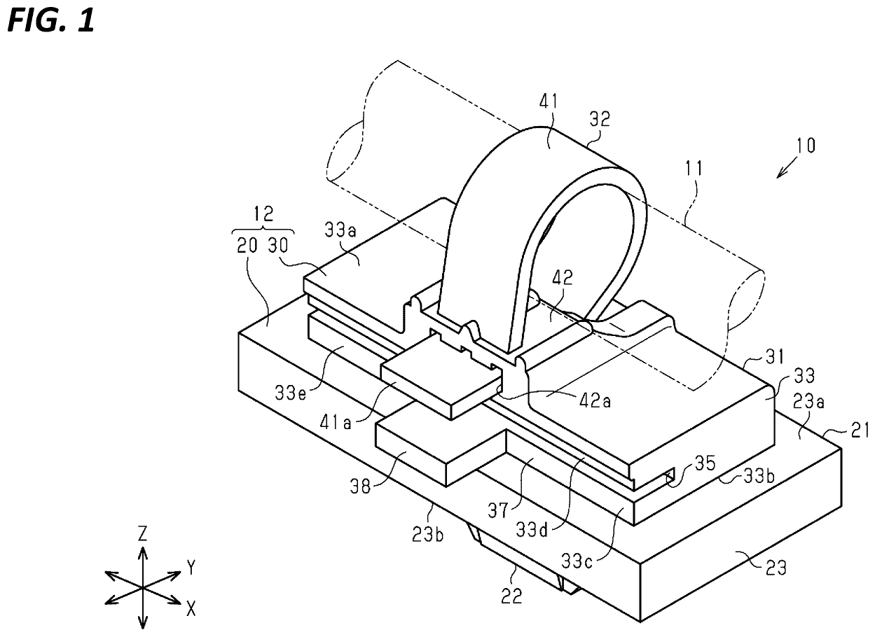

As shown in FIG. 1, a wiring harness 10 of this embodiment is, for example, a wiring harness for vehicle. The wiring harness 10 is provided with a wire member 11 and a wiring harness fixture 12.

The wire member 11 includes, for example, a wire bundle, which is a bundle of a plurality of wires. The wire member 11 is electrically connected to an unillustrated electrical device installed in a vehicle. The wire member 11 may include a tubular exterior member for covering the outer periphery of the wire bundle.

### (Configuration of Wiring Harness Fixture 12)

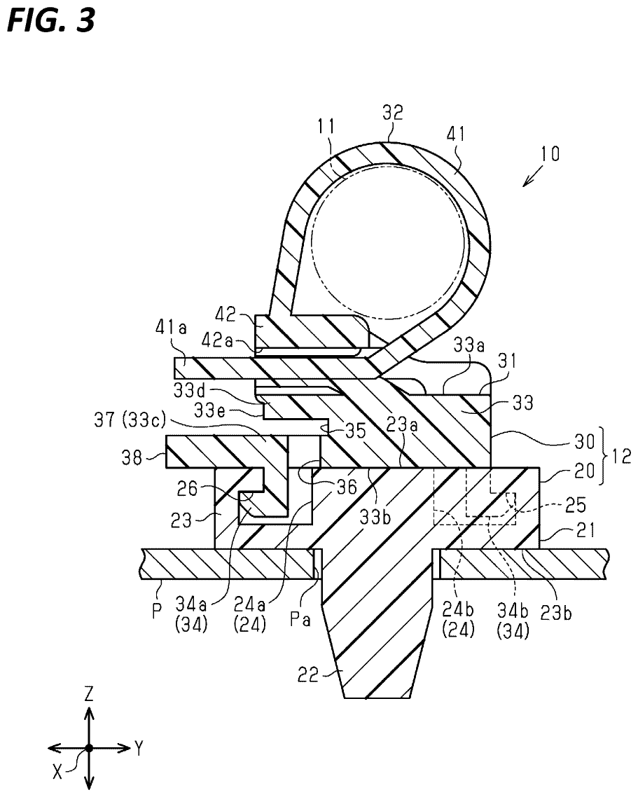

The wiring harness fixture 12 is provided with a fixing member 20 and a wire holding member 30 to be attached to the fixing member 20. The fixing member 20 is fixed to an attachment object P shown in FIG. 3. The attachment object Pis, for example, a body panel of the vehicle. The wire holding member 30 holds the wire member 11. That is, the wire member 11 is fixed to the attachment object P by the wiring harness fixture 12.

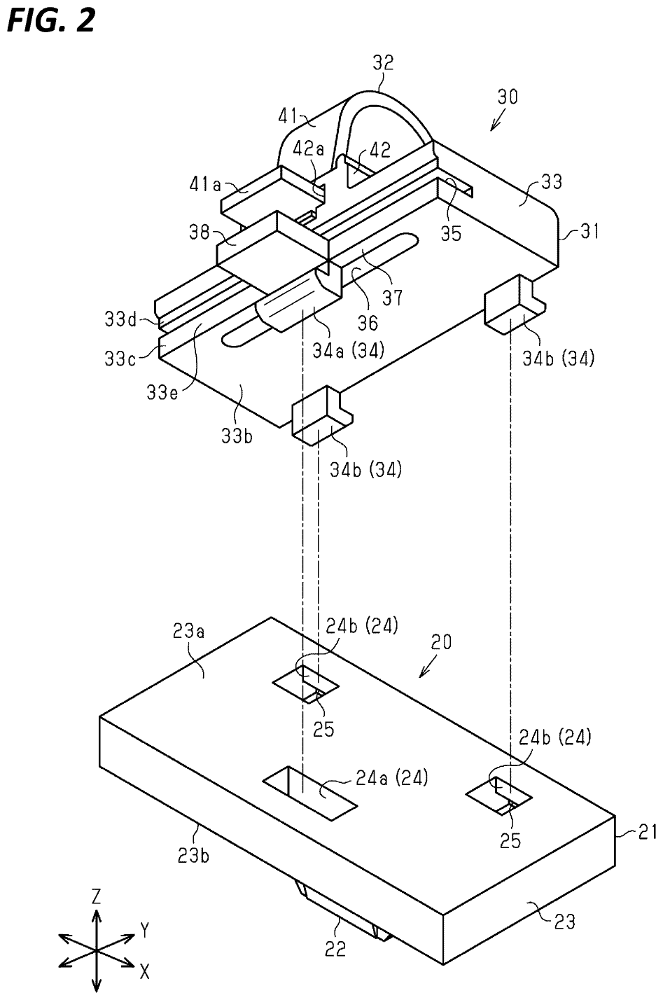

As shown in FIGS. 2 and 3, the wire holding member 30 includes a first coupling portion 31. The fixing member 20 includes a second coupling portion 21 to be detachably coupled to the first coupling portion 31. The wire holding member 30 is separably attached to the fixing member 20 by coupling the first and second coupling portions 31, 21. Note that the fixing member 20 and the wire holding member 30 are, for example, made of synthetic resin.

Note that, in figures, an X axis is an axis along a length direction of the wire member 11. A Y axis is an axis perpendicular to the X axis and parallel to a surface of the attachment object P. Further, a Z axis is an axis along a height direction of the wiring harness fixture 12 and perpendicular to each of the X and Y axes. In the following description, a direction along the X axis is referred to as an X-axis direction, a direction along the Y axis is referred to as a Y-axis direction and a direction along the Z axis is referred to as a Z-axis direction.

### (Configuration of Fixing Member 20)

The fixing member 20 includes the second coupling portion 21 and a fixing portion 22.

The fixing portion 22 is, for example, fixed by being inserted into an attachment hole Pa formed through the attachment object P. The fixing portion 22 includes, for example, a pair of unillustrated locking pieces. The fixing portion 22 is fixed in the attachment hole Pa of the attachment object P by the pair of locking pieces being locked to the attachment object P.

The second coupling portion 21 includes a base portion 23 and locking recesses 24 provided in the base portion 23. The base portion 23 has, for example, a rectangular shape long in the X-axis direction in a plan view, i.e. when viewed from the Z-axis direction. Further, the base portion 23 is substantially in the form of a rectangular parallelepiped. The fixing portion 22 is integrally formed to the base portion 23 to project from one side surface in the Z-axis direction of the base portion 23.

For example, three locking recesses 24 are provided in the base portion 23. In the following description, one of these three locking recesses 24 is referred to as a first locking recess 24a and the remaining two locking recesses 24 are referred to as second locking recesses 24b.

### (Configuration of Wire Holding Member 30)

As shown in FIGS. 1, 2 and 3, the wire holding member 30 includes the first coupling portion 31 and a holding portion 32 for holding the wire member 11. The wire holding member 30 is an injection-molded article in which the first coupling portion 31 and the holding portion 32 are integrally formed. The first coupling portion 31 has, for example, a rectangular shape long in the X-axis direction when viewed from the Z-axis direction.

The first coupling portion 31 includes a base portion 33 and locking claws 34 provided on the base portion 33. The base portion 33 has, for example, a rectangular shape long in the X-axis direction in a plan view, i.e. when viewed from the Z-axis direction. Further, the base portion 33 is substantially in the form of a rectangular parallelepiped. The size of the base portion 33 when viewed from the Z-axis direction is smaller than that of the base portion 23 of the fixing member 20. That is, dimensions of the base portion 33 in the X-axis direction and the Y-axis direction are smaller than those of the base portion 23.

The holding portion 32 is provided on one side surface in the Z-axis direction of the base portion 33. When, out of both side surfaces in the Z-axis direction of the base portion 33, the side surface provided with the holding portion 32 is an upper surface 33a, the locking claws 34 are provided to project from a lower surface 33b of the base portion 33. The lower surface 33b of the base portion 33 is, for example, a flat surface perpendicular to the Z-axis direction. Note that the side of the upper surface 33a in the Z-axis direction in the base portion 33 is referred to as an upper side and the side of the lower surface 33b in the Z-axis direction in the base portion 33 is referred to as a lower side.

An upper surface 23a of the base portion 23 in the fixing member 20 is, for example, a flat surface perpendicular to the Z-axis direction. With the wire holding member 30 attached to the fixing member 20, the lower surface 33b of the base portion 33 is in contact with the upper surface 23a of the base portion 23. The first locking recess 24a and the respective second locking recesses 24b are formed in the upper surface 23a of the base portion 23. Further, the fixing portion 22 is provided on the lower surface 23b of the base portion 23.

### (Configuration of Groove Portion 35)

As shown in FIGS. 1, 2 and 3, a groove portion 35 extending along the X-axis direction is formed in one end part in the Y-axis direction of the base portion 33. The groove portion 35 is, for example, formed from one end to the other end in the X-axis direction in the one end part in the Y-axis direction of the base portion 33. Further, the groove portion 35 is, for example, formed in a central part in the Z-axis direction in the one end part in the Y-axis direction of the base portion 33. In the following description, two parts divided in the Z-axis direction by the groove portion 35 are respectively referred to as a first part 33c and a second part 33d in the one end part in the Y-axis direction of the base portion 33. The first and second parts 33c, 33d face each other in the Z-axis direction across the groove portion 35. The first part 33c is located below the groove portion 35 in the Z-axis direction, and the second part 33d is located above the groove portion 35 in the Z-axis direction.

### (Configurations of Slit 36 and Flexible Portion 37)

As shown in FIGS. 2 and 3, the first part 33c is formed with a slit 36 penetrating through the first part 33c in the Z-axis direction. The slit 36 extends, for example, along the X-axis direction. In the X-axis direction, a length of the slit 36 is, for example, set to be equal to or more than half the length of the base portion 33.

The first part 33c includes a flexible portion 37 outward of the slit 36 in the Y-axis direction. The flexible portion 37 is easily deformed in the Y-axis direction by being formed with the slit 36. In particular, the flexible portion 37 is easily deflected in a direction to narrow a width of the slit 36 in the Y-axis direction.

### (Configuration of Operating Portion 38)

The first part 33c includes an operating portion 38 extending from the flexible portion 37. The operating portion 38 extends from the flexible portion 37 toward a side opposite to the slit 36 along the Y-axis direction. The operating portion 38 is provided at a position corresponding to a central part in the X-axis direction of the slit 36. A tip part in the Y-axis direction of the operating portion 38 projects further outward than an end surface 33e in the Y-axis direction of the base portion 33. The flexible portion 37 is deformed to narrow the width in the Y-axis direction of the slit 36 by the operating portion 38 being pushed in the Y-axis direction.

### (Configuration of Locking Claws 34)

As shown in FIG. 2, three locking claws 34 are, for example, provided on the lower surface 33b of the base portion 33. In the following description, one of these three locking claws 34 is referred to as a first locking claw 34a and the remaining two locking claws 34 are referred to as second locking claws 34b. The first locking claw 34a is inserted into the first locking recess 24a. The respective second locking claws 34b are inserted into the respective second locking recesses 24b.

Each second locking claw 34b is provided on an end part in the Y-axis direction of the lower surface 33b of the base portion 33. Further, each second locking claw 34b is provided on a side opposite to a side where the groove portion 35 is provided in the Y-axis direction. One second locking claw 34b is provided on one side of the central part of the base portion 33 in the X-axis direction, and the other second locking claw 34b is provided on the other side of the central part of the base portion 33 in the X-axis direction. Further, the two second locking claws 34b are provided at positions line-symmetrical with respect to the central part in the X-axis direction.

The respective second locking recesses 24b are provided at positions corresponding to the respective second locking claws 34b in the base portion 23 of the fixing member 20. As shown in FIG. 3, the second locking claw 34b inserted into the second locking recess 24b is locked to a locked portion 25 formed inside the second locking recess 24b in the Z-axis direction. Note that both side surfaces of the second locking claw 34b in the X-axis direction are, for example, in contact with side surfaces of the second locking recess 24b. In this way, rattling between the fixing member 20 and the wire holding member 30 is suppressed. As a result, the wire member 11 can be stably held by the wiring harness fixture 12.

### (Configuration of First Locking Claw 34a)

As shown in FIG. 2, the first locking claw 34a projects downward in the Z-axis direction from the flexible portion 37. The first locking claw 34a is provided at a position corresponding to the central part of the slit 36 in the X-axis direction. That is, the first locking claw 34a is provided at the same position as the operating portion 38 in the X-axis direction. Further, a width of the first locking claw 34a in the X-axis direction is larger than that of each second locking claw 34b in the X-axis direction. Note that widths of the respective second locking claws 34b in the X-axis direction are, for example, set to be equal.

In the base portion 23 of the fixing member 20, the first locking recess 24a is provided at a position corresponding to the first locking claw 34a. As shown in FIG. 3, the first locking claw 34a inserted in the first locking recess 24a is locked to a locked portion 26 formed inside the first locking recess 24a in the Z-axis direction. The first locking claw 34a is displaced inward in the Y-axis direction together with the flexible portion 27 according to an inward displacement in the Y-axis direction of the flexible portion 37. By this inward displacement in the Y-axis direction, the locking of the first locking claw 34a and the locked portion 26 is released. That is, the slit 36 and the flexible portion 37 provided in the first coupling portion 31 constitute a displacement allowing portion for allowing a displacement of the first locking claw 34a in a direction to release locking to the locked portion 26. Note that both side surfaces of the first locking claw 34a in the X-axis direction are, for example, in contact with side surfaces of the first locking recess 24a. In this way, rattling between the fixing member 20 and the wire holding member 30 is suppressed. As a result, the wire member 11 can be stably held by the wiring harness fixture 12.

### (Configuration of Holding Portion 32)

As shown in FIGS. 1 and 3, the holding portion 32 includes, for example, a band portion 41 for surrounding the outer periphery of the wire member 11 and a lock portion 42 for locking the band portion 41. The lock portion 42 is formed on one end in a length direction of the band portion 41. Further, the lock portion 42 is, for example, integrally formed in a central part in the X-axis direction of the base portion 33.

The band portion 41 is wound around the wire member 11, and the tip of the band portion 41 is inserted and locked in a through hole 42a of the lock portion 42. In this way, the wire member 11 is held by the band portion 41 and the lock portion 42. Note that the through hole 42a penetrates, for example, through the lock portion 42 in the Y-axis direction. A tip part 41a of the band portion 41 projects, for example, from the through hole 42a in the Y-axis direction. Further, the tip part 41a of the band portion 41 projects from an end surface 33e of the base portion 33 in the Y-axis direction. That is, the tip part 41a of the band portion 41 projects toward the same side as the operating portion 38 in the base portion 23 in the Y-axis direction.

In the wire holding member 30, the first part 33c and the operating portion 38 of the base portion 33 are, for example, provided side by side in the Z-axis direction with respect to the holding portion 32. The lock portion 42 of the holding portion 32 is provided independently of the operating portion 38 not to interfere with the operating portion 38. In particular, the base portion 33 of the first coupling portion 31 includes the groove portion 35 provided between the operating portion 38 and the holding portion 32. In this way, a force transmitted to the holding portion 32 from the wire member 11 receiving an external force is hardly transmitted to the operating portion 38 and the flexible portion 37 via the lock portion 42.

Functions of this embodiment are described.

The wire holding member 30 for holding the wire member 11 is separable from the fixing member 20. Accordingly, the wire holding member 30 and the wire member 11 can be detached from the attachment object P without detaching the fixing member 20 from the attachment object P. Thus, even if the fixing portion 22 is deformed, for example, due to long-term use in a situation subject to vehicle vibration and, thereby, it becomes difficult to detach the fixing portion 22 from the attachment hole Pa, the wire member 11 can be easily detached from the attachment object P. Further, since the wire holding member 30 can be attached to the fixing member 20 fixed to the attachment object P, a new wire member 11 can be exchanged together with the wire holding member 30.

Effects of this embodiment are described.

(1) The wire holding member 30 is separably attached to the fixing member 20 by coupling the first and second coupling portions 31, 21. According to this configuration, even in a situation where it is difficult to detach the fixing member 20 from the attachment object P, the wire member 11 can be easily detached, together with the wire holding member 30, from the fixing member 20 fixed to the attachment object P by releasing a coupled state of the first and second coupling portions 31, 21.

(2) The first coupling portion 31 includes the locking claws 34. The second coupling portion 21 includes the locked portions 25, 26 to be locked by the locking claws 34. According to this configuration, the wire holding member 30 can be attached to the fixing member 20 by locking the locking claws 34 of the first coupling portion 31 and the locked portions 25, 26 of the second coupling portion 21.

(3) A plurality of the locking claws 34 and a plurality of the locked portions 25, 26 are provided. According to this configuration, the first and second coupling portions 31, 21 can be firmly coupled by a plurality of pairs of the locking claw 34 and the locked portion 25, 26. Further, by providing the plurality of locking claws 34 and the plurality of locked portions 25, 26, it is possible to reduce a load applied to one locking claw 34 during vehicle vibration or the like.

(4) The slit 36 and the flexible portion 37 provided in the first coupling portion 31 constitute the displacement allowing portion for allowing a displacement of the first locking claw 34a in the direction to release locking to the locked portion 26. According to this configuration, the locking of the first locking claw 34a to the locked portion 26 can be easily released by displacing the locking claw 34 by the displacement allowing portion constituted by the slit 36 and the flexible portion 37.

(5) The first coupling portion 31 includes the operating portion 38 for displacing the first locking claw 34a in cooperation with the displacement allowing portion. According to this configuration, the locking claw 34 can be easily displaced by the operating portion 38. Therefore, the locking of the first locking claw 34a to the locked portion 26 can be easily released by the operating portion 38.

(6) The fixing member 20 includes the second coupling portion 21. The wire holding member 30 includes the first coupling portion 31 having the operating portion 38 and the holding portion 32 for holding the wire member 11. In the wire holding member 30, the holding portion 32 is provided independently of the operating portion 38 not to interfere with the operating portion 38. According to this configuration, a force transmitted from the wire member 11 can be made less likely to be transmitted to the operating portion 38 via the holding portion 32. Therefore, it can be suppressed that the operating portion 38 is moved by the force transmitted from the wire member 11 and, as a result, the locking claw 34 is displaced and the locking to the locked portion 26 is inadvertently released.

(7) The first coupling portion 31 includes the groove portion 35 provided between the operating portion 38 and the holding portion 32. According to this configuration, the holding portion 32 can be configured not to interfere with the operating portion 38 by the groove portion 35 provided between the holding portion 32 and the operating portion 38.

(8) The first coupling portion 31 includes the base portion 33. The plurality of locking claws 34 extend from the lower surface 33b of the base portion 33. The operating portion 38 projects from the end surface 33e of the base portion 33. According to this configuration, the operating portion 38 can be easily operated since projecting from the base portion 33.

(9) The holding portion 32 includes the tip part 41a of the band portion 41 as a projecting portion projecting from the end surface 33e of the base portion 33. According to this configuration, the tip part 41a of the band portion 41 and the operating portion 38 project from the same end surface 33e of the base portion 33. Thus, parts projecting from the base portion 33 can be collected on the same end surface 33e. Therefore, the interference of the wiring harness fixture 12 and peripheral components can be suppressed.

(10) The displacement allowing portion provided in the first coupling portion 31 includes the slit 36 formed in the first coupling portion 31 and the flexible portion 37 enabled to be deflected by the slit 36. The first locking claw 34a is provided on the flexible portion 37. According to this configuration, the first locking claw 34a can be easily displaced by the slit 36 and the flexible portion 37 provided in the first coupling portion 31. Therefore, the locking of the first locking claw 34a to the locked portion 26 can be more easily released.

(11) The operating portion 38 is provided at the position corresponding to the central part in an extension direction of the slit 36 in the flexible portion 37. According to this configuration, the flexible portion 37 is easily deflected in the central part in the extension direction of the slit 36. That is, since the operating portion 38 is provided in an easily deflected part of the flexible portion 37, the locking of the first locking claw 34a to the locked portion 26 can be easily released by the operating portion 38.

(12) The width of the first locking claw 34a is set to be larger than that of each of the plurality of second locking claws 34b. According to this configuration, the first and second coupling portions 31, 21 can be suitably coupled by setting the width of the first locking claw 34a larger than that of each second locking claw 34b. In this embodiment, the first locking claw 34a to be displaced is provided near one end part in the Y-axis direction of the base portion 33, and the two immovable second locking claws 34b are provided near the other end part in the Y-axis direction of the base portion 33. Only one first locking claw 34a is provided in the central part in the X-axis direction where a deflection amount is easily ensured in the flexible portion 37. In this way, since a load is more easily applied to the first locking claw 34a, the wire member 11 can be stably held by setting the width of the first locking claw 34a larger than that of each second locking claw 34b.

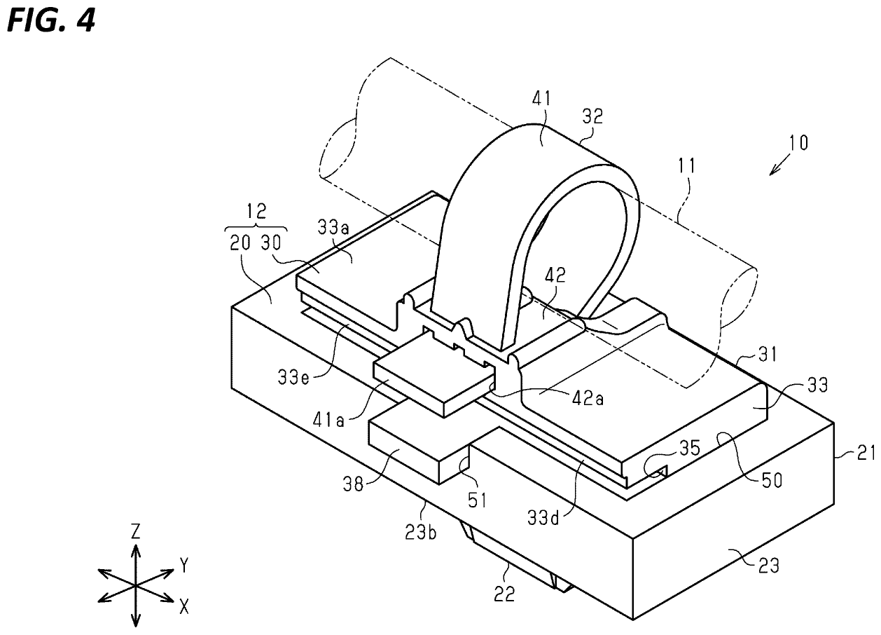

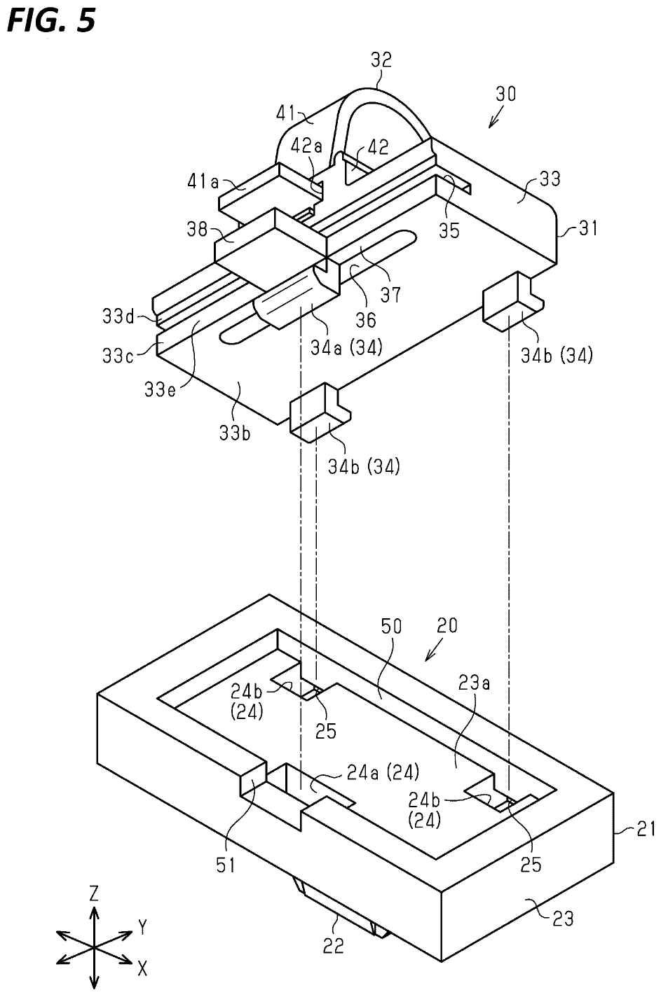

This embodiment can be modified and carried out as follows. This embodiment and the following modifications can be carried out in combination without technically contradicting each other.
As shown in FIGS. 4 and 5, the base portion 23 of the second coupling portion 21 may include a recess 50, into which a part of the base portion 33 of the first coupling portion 31 is fit. A part in the Z-axis direction of the base portion is fit into the recess 50. The recess 50 and the base portion 33 can contact each other in the X-axis direction and the Y-axis direction. According to this configuration, rattling between the fixing member 20 and the wire holding member 30 can be suppressed. As a result, the wire member 11 can be stably held by the wiring harness fixture 12. Further, the base portion 33 contacts inner side surfaces of the recess 50 in the X-axis direction and the Y-axis direction, whereby a load applied to each locking claw 34 during vehicle vibration or the like can be reduced.

Note that the base portion 23 configured as shown in FIGS. 4 and 5 includes a cut portion 51 connected to the recess 50. The operating portion 38 is fit into the cut portion 51. The operating portion 38 projects in the Y-axis direction through the cut portion 51.
The width of the first locking claw 34a may be equal to or smaller than that of each second locking claw 34b.
Although the plurality of second locking recesses 24b are provided to correspond to the plurality of second locking claws 34 in the above embodiment, the respective second locking recesses 24b may be, for example, connected to each other instead.
The number of the first locking claw 34a and that of the first locking recess 24a including the locked portion 26 are not limited to those in the above embodiment and may be two or more.
The number of the second locking claws 34b and that of the second locking recesses 24b including the locked portion 25 are not limited to those in the above embodiment and may be one, three or more.
Although the displacement allowing portion including the slit 36 and the flexible portion 37 and the operating portion 38 are provided side by side in the Z-axis direction with respect to the lock portion 42 of the holding portion 32 in the wire holding member 30 of the above embodiment, there is no particular limitation to this. For example, the displacement allowing portion including the slit 36 and the flexible portion 37 and the operating portion 38 may be provided side by side in the X-axis direction with respect to the lock portion 42.
The configuration of the displacement allowing portion for allowing the first locking claw 34a to be displaced in the direction to release the locking to the locked portion 26 is not limited to that of the first embodiment and can be changed as appropriate.
The shape of each base portion 23, 33 when viewed from the Z-axis direction is not limited that of the above embodiment and can be changed as appropriate according to the configuration of the wiring harness fixture 12.
The size of the base portion 33 of the first coupling portion 31 when viewed from the Z-axis direction may be nearly the same as that of the base portion 23 of the fixing member 20. Further, the size of the base portion 33 of the first coupling portion 31 when viewed from the Z-axis direction may be larger than that of the base portion 23 of the fixing member 20.
The fixing member 20 may include the first coupling portion 31 having the locking claws 34, and the wire holding member 30 may include the second coupling portion 21 having the locked portions 25, 26.
The configuration of the holding portion 32 is not limited to that in the above embodiment and may be changed as appropriate according to the configuration.
The configuration of the fixing portion 22 is not limited to that in the above embodiment and may be changed as appropriate according to the configuration.
As shown in FIG. 2, the locking recess 24 may have an opening in the upper surface 23a of the base portion 23. As shown in FIGS. 2 and 3, a width in the Y-axis direction of the opening edge of the locking recess 24 may be smaller than that inside the locking recess 24.
As shown in FIGS. 2 and 3, the locked portion 26 may be formed such that an outer edge part in the Y-axis direction of the opening of the first locking recess 24a protrudes further inward in the Y-axis direction than the inside of the first locking recess 24a, and the locked portion 25 may be formed such that an outer edge part in the Y-axis direction of the opening of the second locking recess 24b protrudes further inward in the Y-axis direction than the inside of the second locking recess 24b.
As shown in FIGS. 2 and 3, the locking claw 34 may have a base end projecting in the Z-axis direction from the lower surface 33b of the base portion 33 and a tip extending outward in the Y-axis direction from the base end of the locking claw 34. With the tip of the first locking claw 34a locked to the locked portion 26 in the Z-axis direction, a gap for allowing a displacement of the first locking claw 34a is formed to be continuous with the slit 36 in the Z-axis direction between the base end of the first locking claw 34a and an inner edge part in the Y-axis direction of the opening of the first locking recess 24a. With the tip of the second locking claw 34b locked to the locked portion 25 in the Z-axis direction, a gap for allowing a displacement of the second locking claw 34b is formed between the base end of the second locking claw 34b and an inner edge part in the Y-axis direction of the opening of the second locking recess 24b.
As shown in FIGS. 2 and 3, a width of the flexible portion 37 in a deflection direction (Y-axis direction) of the flexible portion 37 may be equal to that of the first locking claw 34a, and a thickness of the flexible portion 37 may be smaller than that of the first locking claw 34a in an insertion direction (Z-axis direction) of the first locking claw 34a.
The fixing member 20 may be a one-piece product made of first synthetic resin. The wire holding member 30 may be a one-piece product made of second synthetic resin, which is the same as or different from the first synthetic resin.
The embodiment and the modifications disclosed this time are illustrative in all aspects and the present invention is not limited to these illustrations. That is, the scope of the present invention is represented by claims and intended to include all changes in the scope of claims and in the meaning and scope of equivalents.

List of Reference Numerals

| | |
|---|---|
| 10 | wiring harness |
| 11 | wire member |
| 12 | wiring harness fixture |
| 20 | fixing member |
| 21 | second coupling portion |
| 22 | fixing portion |
| 23 | base portion |
| 23a | upper surface |
| 23b | lower surface |
| 24 | locking recess |
| 24a | first locking recess |
| 24b | second locking recess |
| 25 | locked portion |
| 26 | locked portion |
| 30 | wire holding member |
| 31 | first coupling portion |
| 32 | holding portion |
| 33 | base portion |
| 33a | upper surface |
| 33b | lower surface |
| 33c | first part |
| 33d | second part |
| 33e | end surface |
| 34 | locking claw |
| 34a | first locking claw |
| 34b | second locking claw |
| 35 | groove portion |
| 36 | slit (displacement allowing portion) |
| 37 | flexible portion (displacement allowing portion) |
| 38 | operating portion |
| 41 | band portion |
| 41a | tip part of band portion (projecting portion) |
| 42 | lock portion |
| 42a | through hole |
| 50 | recess |
| 51 | cut portion |
| P | attachment object |
| Pa | attachment hole |

1. A wiring harness fixture, comprising:
a fixing member to be fixed to an attachment object; and
a wire holding member for holding a wire member,
one of the fixing member and the wire holding member including a first coupling portion,
the other of the fixing member and the wire holding member including a second coupling portion to be detachably coupled to the first coupling portion, and
the wire holding member being separably attached to the fixing member by coupling the first and second coupling portions.

2. The wiring harness fixture of claim 1, wherein:
the first coupling portion includes a locking claw, and
the second coupling portion includes a locked portion to be locked by the locking claw.

3. The wiring harness fixture of claim 2, wherein a plurality of the locking claws and a plurality of the locked portions are provided.

4. The wiring harness fixture of claim 3, wherein the first coupling portion includes a displacement allowing portion for allowing a displacement of one of the plurality of locking claws in a direction to release locking to the locked portion.

5. The wiring harness fixture of claim 4, wherein the first coupling portion includes an operating portion for displacing the locking claw in cooperation with the displacement allowing portion.

6. The wiring harness fixture of claim 5, wherein:
the fixing member includes the second coupling portion,
the wire holding member includes the first coupling portion having the operating portion and a holding portion for holding the wire member, and
the holding portion is provided independently of the operating portion not to interfere with the operating portion in the wire holding member.

7. The wiring harness fixture of claim 6, wherein the first coupling portion includes a groove portion provided between the operating portion and the holding portion.

8. The wiring harness fixture of claim 6, wherein:
the first coupling portion includes a base portion,
the plurality of locking claws extend from the base portion, and
the operating portion projects from an end surface of the base portion.

9. The wiring harness fixture of claim 8, wherein the holding portion includes a projecting portion projecting from the end surface of the base portion.

10. The wiring harness fixture of claim 4, wherein:
the displacement allowing portion includes a slit formed in the first coupling portion and a flexible portion deflectable due to presence of the slit, and
the locking claw allowed to be displaced by the displacement allowing portion is provided on the flexible portion.

11. The wiring harness fixture of claim 10, wherein:
the first coupling portion includes an operating portion for displacing the locking claw in cooperation with the displacement allowing portion, and
the operating portion is provided at a position corresponding to a central part in an extension direction of the slit in the flexible portion.

12. The wiring harness fixture of claim 4, wherein:
the locking claw allowed to be displaced by the displacement allowing portion is a first locking claw and each locking claw other than the first locking claw, out of the plurality of locking claws, is a second locking claw,
one first locking claw is provided,
a plurality of the second locking claws are provided, and
a width of the first locking claw is set to be larger than that of each of the plurality of second locking claws.

13. A wiring harness, comprising:
the wiring harness fixture of claim 1; and
a wire member to be held by the wire holding member of the wiring harness fixture.
